(19) United States
(12) Patent Application Publication
(10) Pub. No.: US 2020/0269396 A1
(43) Pub. Date: Aug. 27, 2020

(54) PROTECTION METHOD FOR ELECTRIC WRENCH MOTOR AND ELECTRIC WRENCH THEREOF

(71) Applicant: Bobby Hu, Taichung City (TW)

(72) Inventor: Bobby Hu, Taichung City (TW)

(21) Appl. No.: 16/461,964

(22) PCT Filed: Nov. 21, 2016
(86) PCT No.: PCT/CN2016/106636

§ 371 Date: May 17, 2019

(51) Int. Cl. B25B 21/00; B25B 13/46

(52) U.S. Cl. CPC B25B 21/004; B25B 13/462

(57) ABSTRACT

An electric wrench, which is operated in an electric mode and a manual mode, includes a wrench body having a head portion having a ratchet device and a handle portion; a motor disposed in the handle portion; a current sensor connected with the motor for detecting an operation current value of the motor; a controller connected with the current sensor, the controller having a setting unit and a comparing unit, the setting unit setting a threshold current value, the comparing unit comparing the operation current value and the threshold current value; a switch activating and deactivating an operation of the motor; and a warning device connected with the controller. In the electric mode, when the operation current value is greater than the threshold current value, the warning device is triggered for user to switch to the manual mode.

### BACKGROUND OF THE INVENTION

### 1. Field of the Invention

The present invention relates to electric wrenches, and more particularly, to a method for protecting an electric wrench motor. When the motor is in a high-load status, a warning signal is sent out for reminding the user to stop the operation of the motor, so as to prevent the motor from damage.

### 2. Description of the Related Art

Referring to US20080271574A1, an interchangeably manual or automatic ratchet wrench is disclosed. In the electric operation mode, an electric hand grip has a motor placed therein is coupled to the rear end of the handle, and a first transmission rod is mounted on the output spindle of the motor, such that the power output by the output spindle is transmitted to the first transmission rod. By gearing the teeth of the first transmission rod with the pin of the second transmission rod, the power is then transmitted to the second transmission rod, whereby the second transmission rod drives the ratchet head to operate for facilitating the automatically assembling and disassembling operation. In the manual operation mode, the sleeve head of the hand grip is mounted on the first transmission rod of the handle, such that the hand grip is manually rotated for driving the sleeve head to revolve, such that the power is transmitted to the first transmission rod, the second transmission rod, and the ratchet head, facilitating the manual assembling and disassembling operation.

The abovementioned ratchet wrench tool is automatically or manually operated for taking out or positioning the target object. However, during the removing or positioning operation of a screw member, when the screw member has rusted or damaged portions thereon, the target object is stuck and unable to be moved, causing an increasing load of the motor, further causing the motor to overheat and be damaged. As a result, the ratchet wrench tool is damaged.

The abovementioned ratchet wrench tool does not have any functions for ceasing the operation or notifying the user to stop the operation of the motor when the motor is in a high-load situation. As a result, the motor is easily broken due to improper usage, and the safety of usage is challenged. Therefore, it is desirable for the industry to improve the protection upon the motor, reduce the chance of motor damage, and enhance the safety of usage of the device.

### SUMMARY OF THE INVENTION

For improving the issues above, a protection method for electric wrench motor is disclosed. When the fastening member is driven to rotate on a screw member, by detecting the operation current value of the motor through the current sensor, the comparing unit of the controller compares the operation current value and the predetermined threshold current value. Upon the operation current value being greater than the threshold current value, the warning device is trigger for reminding the user to stop the operation of the motor and switch the wrench to the manual mode. Therefore, when the motor reach a high-load status, the operation is immediately halted, thus achieving a motor protection effect.

For achieving the aforementioned objectives, an electric wrench is provided which is operated in an electric mode and a manual mode. In the electric mode, a first torque is applied for driving a fastening member to rotate on a screw member. In the manual mode, a second torque is applied for loosening or releasing the fastening member with respect to the screw member. The first torque is smaller than the second torque. The electric wrench comprises:

a wrench body with one end having a head portion and an opposite end having a handle portion, a ratchet device rotatable disposed on the head portion for driving a fastening member, a transmission shaft disposed in the handle portion, the transmission shaft having one end connected with the ratchet device;

a motor disposed in the handle portion and connected with another end of the transmission shaft;

a current sensor electrically connected with the motor for detecting an operation current value of the motor;

a controller electrically connected with the motor and the current sensor, the controller having a setting unit and a comparing unit, the setting unit applied for setting a threshold current value, the comparing unit applied for comparing the operation current value and the threshold current value;

a switch disposed on the handle portion and electrically connected with the controller for activating and deactivating an operation of the motor; and

a warning device electrically connected with the controller,

wherein, in the electric mode, when the operation current value is greater than the threshold current value, the warning device is triggered for reminding a user to stop operating, so as to switch the wrench to the manual mode.

Preferably, a powering device is further included, which is electrically connected with the controller and the motor. The powering device has a positive voltage and a negative voltage that for providing the positive voltage and the negative voltage needed by the controller and the motor. Also, the warning device is a buzzer.

Preferably, the current value output by the power device is equal to the operation current value, and the threshold current value is about 70% to 80% of the operation current value.

Preferably, the operation current value is between 1.5 amperes to 6.5 amperes.

Preferably, the warning device has a first connection pin electrically connected with the controller and a second connection pin electrically connected with the positive voltage. When the controller provides a low level signal to the warning device, the warning device is triggered. When the controller provides a high level signal to the warning device, the warning device is not triggered.

Preferably, a first transistor is electrically connected between the first connection pin and the controller; a first resistor is electrically connected between the second connection pin and the positive voltage; the base of the transistor is electrically connected with one end of a second resistor, with another end of the second resistor electrically connected with the controller; and the collector of the transistor is electrically connected with the first connection pin.

Preferably, the power amount provided by the powering device is between 3 coulombs to 4 coulombs, the positive voltage is between 3 volts to 12 volts, and the negative voltage is 0 volts.

Preferably, the switch is applied for controlling the motor to drive the transmission shaft to rotate clockwise or counterclockwise. The ratchet device further comprises a direction changing member, such that the rotation direction of the ratchet device is allowed to be oppositely switched. When the switch and the direction changing member define different directions, such that the rotation direction of the transmission shaft and the ratchet device being different, the warning device is triggered.

Preferably, the setting unit is applied for setting a low-load current value, and the comparing unit is applied for comparing the low-load current value with the operation current value. When the operation current value is smaller than or equal to the low-load current value, the controller triggers the warning device.

Preferably, the threshold current value is greater than the low-load current value.

Preferably, the threshold current value is greater than 2 to 3 times the low-load current value.

Preferably, the controller has a timing unit, and the setting unit is applied for setting a continuous time. The timing unit is applied for calculating the continuous time. When the warning device is trigger, the timing unit is triggered as well. During the continuous time, when the operation current value is smaller than the threshold current value, the warning device is stopped being triggered. The continuous time is 2 to 6 seconds.

For achieving the aforementioned objectives, a protection method for electric wrench motor is provided, wherein the electric wrench is operated in an electric mode or a manual mode. In the electric mode, a motor applies a first torque for driving a fastening member to rotate on a screw member. In the manual mode, the motor applies a second torque for loosening or releasing the fastening member with respect to the screw member. The first torque is smaller than the second torque. The protection method comprises following steps: the motor is electrically connected with a current sensor, a controller, and a warning device, respectively. The current sensor is applied for detecting the operation current of the motor. The controller is applied for setting a threshold current value. During the electric driving operation, the current sensor detects the operation current value of the motor. When the operation current value is greater than the threshold current value, the controller triggers the warning device for reminding the user to stop the operation of the motor, so as to switch the wrench to the manual mode.

Preferably, upon the warning device being triggered, when the operation current value is smaller than the threshold current value during a continuous time, the warning device is stopped being trigger.

Preferably, the controller is applied for setting a low-load current value. When the operation current value is smaller or equal to the low-load current value, the warning device is triggered for reminding the user to stop the operation of the motor, so as to switch the wrench to the manual mode.

With such configuration, in the electric mode, when the fastening member meets a damaged or rusted portion of the screw member during the electric driving operation, while the comparing unit indicates that the operation current value is greater than the threshold current value, the controller triggers the warning device for reminding the user to stop the operation of the motor, so as to switch the wrench to the manual mode, and move the fastening member away from the damaged or rusted portion on the screw member. Therefore, when the motor is in the high-load situation, the wrench is switched from the electric mode to the manual mode, thus preventing the motor from being burnt out and securing the operation safety.

Further, when the warning device is trigger, the timing unit is simultaneously triggered. If the damaged or rusted portion on the screw member is relatively narrow, or the fastening member is stuck for a short moment, upon the fastening member leaving the damaged, rusted, or stuck portion on the screw member in the continuous time, and upon the comparing unit acquiring that the operation current value is smaller than the threshold current value, the warning device is stopped being triggered, so that the user is allowed to continue electrically driving the fastening member to rotate on the screw member with the first torque. Thus, the convenience of usage is achieved.

In addition, when the rotation direction of the motor defined by the switch and rotation direction of the ratchet device defined by the direction changing member are different, while the comparing unit determines that the operation current value is smaller than or equal to the low-load current value, the controller triggers the warning device, so as to notify the user of that the rotation directions of the motor and the ratchet device are inconsistent, thus reminding the user to switch the rotation direction or stop the operation. Thus, a double-protection and a fool-proofing functions are achieved.

### BRIEF DESCRIPTION OF THE DRAWINGS

FIG. 1 is a schematic perspective view of the present invention.

FIG. 2 is a structural block diagram of the present invention.

FIG. 3 is another flow chart of the present invention, illustrating that the operation current value is greater than the threshold current value to trigger the warning device.

FIG. 4 is another flow chart of the present invention, illustrating the determination of whether the operation current value is smaller than the threshold current value after the warning device being triggered.

FIG. 5 is another flow chart of the present invention, illustrating the determination of whether the directions defined by the direction changing member and the switch are identical.

FIG. 6 is a schematic circuit diagram, illustrating the connection relationship among the controller, the motor, and the warning device.

FIG. 7 is another schematic circuit diagram, illustrating that the transistor is electrically connected between the controller and the warning device.

### DETAILED DESCRIPTION OF THE INVENTION

Please note that, the aforementioned central concept in the summary of the present invention will be understood by reference to the description of the preferred embodiment in conjunction with the accompanying drawings where the components are illustrated based on possible proportions, sizes, variations, or displacements for explanation but not subject to the actual component proportion.

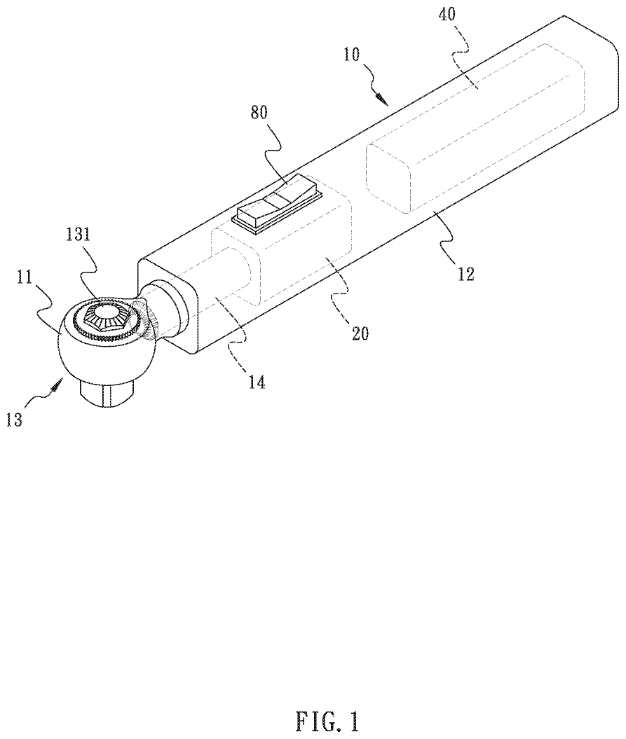

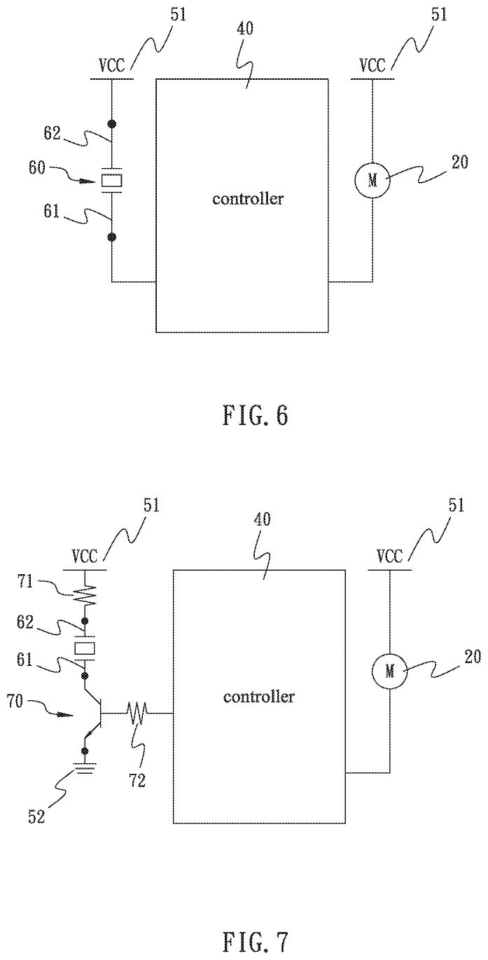

Referring to FIG. 1 to FIG. 7, an electric wrench is provided for being operated in an electric mode and a manual mode. In the electric mode, a first torque is applied for driving a fastening member to rotate on a screw member. In the manual mode, a second torque is applied for fastening or loosening the fastening member with respect to the screw member. The first torque is smaller than the second torque. The longitudinal length of the screw member is greater than times the height of the fastening member. In an embodiment of the present invention, the screw member is a thread bolt, and the fastening member is a nut. The electric wrench comprises a wrench body 10, a motor 20, a controller 40, a powering device 50, a warning device 60, and a switch 80.

The wrench body 10 has one end provided with a head portion 11 and an opposite end provided with a hollow handle portion 12. A ratchet device 13 is disposed on the head portion 11 for combining the fastening member, so as to drive the fastening member to rotate on the screw member. A transmission shaft 14 is disposed in the handle portion 12, with one end of the transmission shaft 14 connected with the ratchet device 13. Also, the ratchet device 13 has a direction changing member 131 pivotally disposed on the head portion 11, wherein the direction changing member 131 is allowed to be changed between opposite directions, so as to control the ratchet device 13 to rotate clockwise or counterclockwise.

The motor 20 is disposed in the handle portion 12 and connected with another end of the transmission shaft 14. The motor 20 drives the transmission shaft 14 to rotate, thereby controlling the ratchet device 13 to drive the fastening member to rotate on the screw member. In an embodiment of the present invention, the motor 20 is a direct current (DC) motor. Also, the motor 20 is electrically connected with a current sensor 30. The current value signal generated by the current sensor 30 is an analog signal. The current sensor 30 is applied for detecting an operation current value 21 of the motor 20. In an embodiment of the present invention, the operation current value 21 of the motor 20 is between 1.5 amperes to 6.5 amperes.

The controller 40 is connected with the motor 20 and the current sensor 30. The controller 40 has a setting unit 41 and a comparing unit 42. The setting unit 41 is applied for setting a threshold current value 411 and a low-load current value 412. The comparing unit 42 is applied for comparing the operation current value 21 and the threshold current value 411 or the low-load current value 412. In an embodiment of the present invention, the threshold current value 411 is about 70% to 80% of the operation current value 21, and the threshold current value 411 is greater than the low-load current value 412. In an embodiment of the present invention, the threshold current value 411 is greater than 2 to 3 times the low-load current value 412, and the low-load current value 412 is smaller than 0.6 amperes or approximately 0 amperes.

Also, the controller 40 has a timing unit 43. The setting unit 41 is applied for setting a continuous time 413, and the timing unit 43 is applied for calculating the continuous time 413. The continuous time 413 is between 2 seconds to 6 seconds. In an embodiment of the present invention, the continuous time 413 is between 3 seconds to 5 seconds.

The powering device 50 is electrically connected with the motor 20 and the controller 40. The powering device 50 has a positive voltage 51 and a negative voltage 52 for providing the positive voltage and negative voltage needed by the motor 20 and the controller 40. Therein, the current value output by the powering device 50 is equal to the operation current value 21. In addition, the powering device 50 is allowed to be a rechargeable type or battery type. In an embodiment of the present invention, the powering device 50 is a rechargeable battery. The power amount provided by the powering device 50 is between 3 coulombs to 4 coulombs, the positive voltage is between 3 volts to 12 volts, and the negative voltage is 0 volts.

The warning device 60 is electrically connected with the controller 40. The warning device 60 is allowed to be selected from a group consisting of a buzzer, a display light, a vibrator, or any combination thereof. In an embodiment of the present invention, the warning device 60 is a buzzer. The warning device 60 has a first connection pin 61 and a second connection pin 62. The first connection pin 61 is electrically connected with the controller 40, and the second connection pint 62 is electrically connected with the positive voltage 51. When the controller 40 provides a low level signal to the warning device 60, a potential difference exists between the controller 40 and the warning device 60, such that the warning device 60 is triggered. When the controller 40 provides a high level signal to the warning device 60, no potential difference exist between the controller 40 and the warning device 60, such that the warning device 60 is not triggered. In addition, for enlarging the current value output from the powering device 50 in order to trigger the warning device 60, a transistor 70 is electrically connected between the first connection pin 61 and the controller 40, a first resistor 71 is electrically connected with the second connection pin 62 and the positive voltage 51, the base of the transistor 70 is electrically connected with one end of a second resistor 72, another end of the second resistor 72 is electrically connected with the controller 40, and the collector of the transistor 70 is electrically connected with the first connection pin 61. In an embodiment of the present invention, the transistor 70 is an N—P—N type transistor.

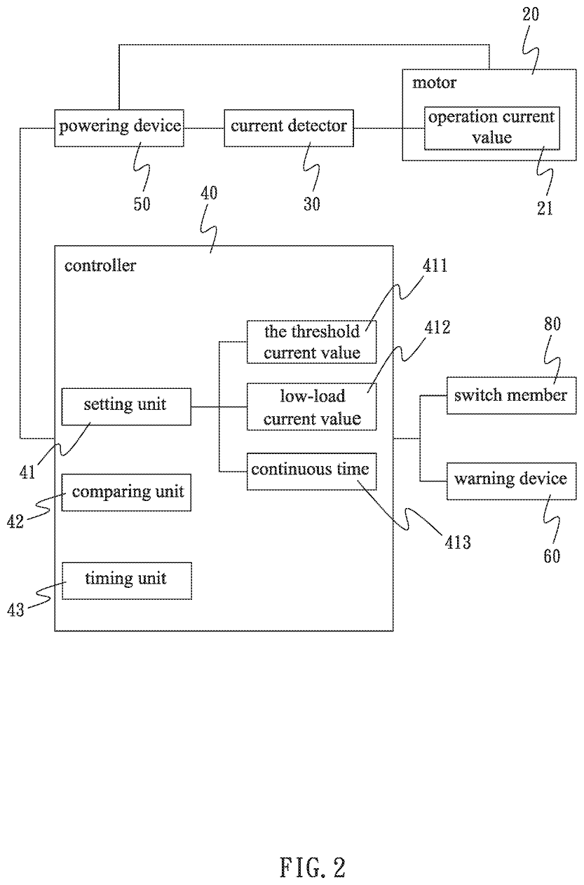

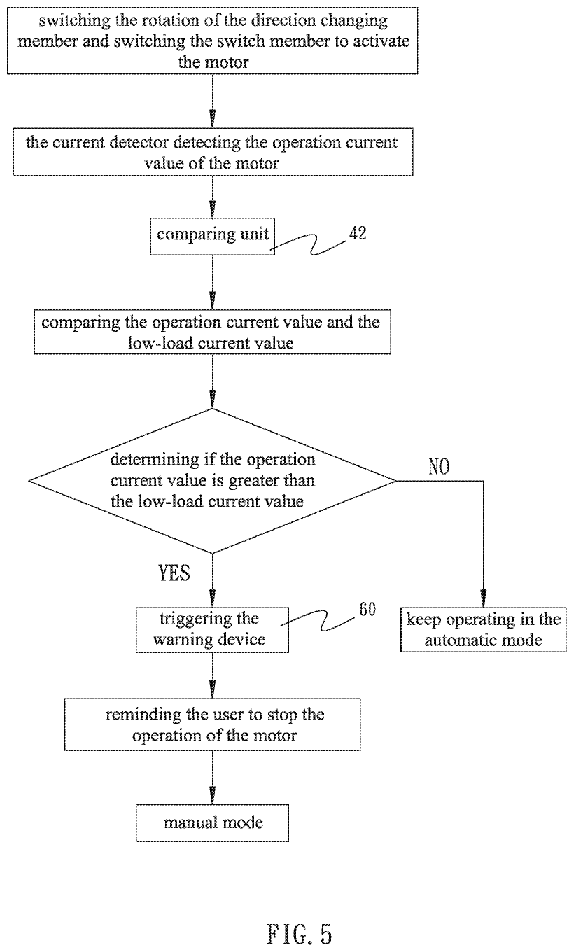

The switch 80 is disposed on the outer side of the handle portion 12 and electrically connected with the controller 40 for activating and deactivating the operation of the motor 20. In an embodiment of the present invention, the switch 80 is a three-stage rocker switch. When the switch 80 is switched to left or right stage, the motor 20 is controlled to drive the transmission shaft 14 to rotate clockwise or counterclockwise. When the switch 80 is switched to the middle stage, the motor 20 stops operating. Further, referring to FIG. 1, FIG. 2, and FIG. 5, when the rotation direction of the ratchet device 13 defined by direction changing member 131 and the rotation direction of the transmission shaft 14 defined by the switch 80 are inconsistent, the ratchet device 13 idles, and the motor 20 is in a non-load status. In other words, if the switch 80 is switched to one side to control the motor 20 to drive the transmission shaft 14 to rotate clockwise, but the direction changing member 131 is switched to drive the ratchet device 13 to rotate counterclockwise, the ratchet device 13 idles, and the motor 20 is in a non-load status. At the same time, the operation current value 21 of the motor 20 is sent to the comparing unit 42, and the comparing unit 42 compares the operation current value 21 with the low-load current value 412. If the operation current value 21 is smaller than or equal to the low-load current value 412, the controller 40 triggers the warning device 60 for notifying the user that the rotation directions of the motor 20 and the ratchet device 13 are inconsistent, so as to remind the user to switch the rotation direction or stop the operation, achieving a double-protection and a fool-proofing functions.

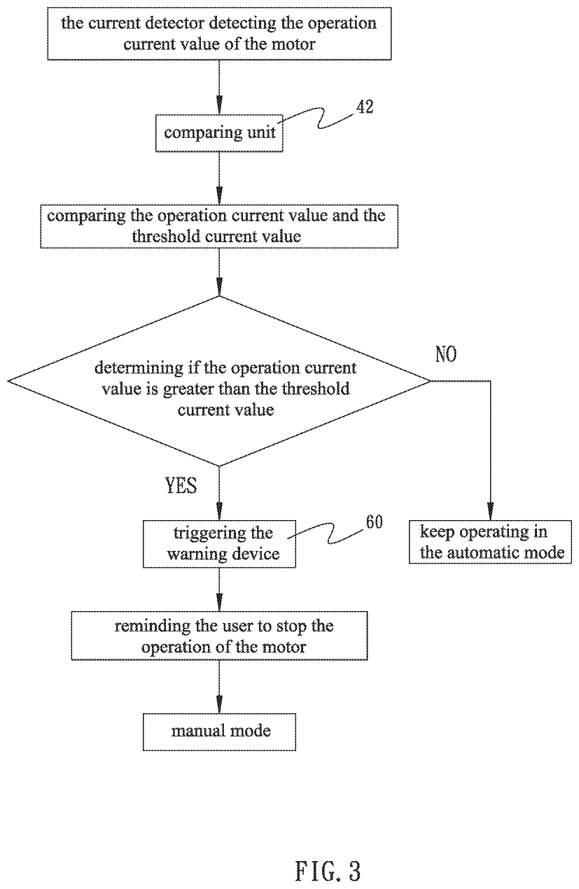

Therefore, as shown by FIG. 2 and FIG. 3, the user is allowed to operate the present invention in the electric or manual mode. The current sensor 30 is applied for detecting the operation current value 21, and sending the operation current value 21 in an analog signal form to the comparing unit 42 of the controller 40, such that the operation current value 21 is compared with the threshold current value 411. In the electric mode, the switch 80 controls the motor 20 to drive the rotation of the transmission shaft 14, and the ratchet device 13 drives the fastening member to rotate with respect to the screw member, whereby the fastening member is efficiently fastened to or released from the screw member. During the rotation, when the fastening member meets a rusted or damage portion on the screw member, the fastening member is stuck, such that the motor 20 continuously raises the operation current value 21 for the driving the transmission shaft 14 to rotate. When the operation current value 21 is greater than the threshold current value 411, the controller 40 transforms the analog signal into a digital signal through an analog-to-digital converter (A/D), and provides a low level signal to the warning device 60, such that the warning device 60 is triggered for reminding the user to stop the operation of the motor 20 and switch to the manual mode. In the manual mode, the user applies the second torque to operate the wrench of the present invention, so as to drive the fastening member to leave the rusted or damaged portion of the screw member. Therefore, the motor 20 is prevented from burning out, and the operation safety is secured.

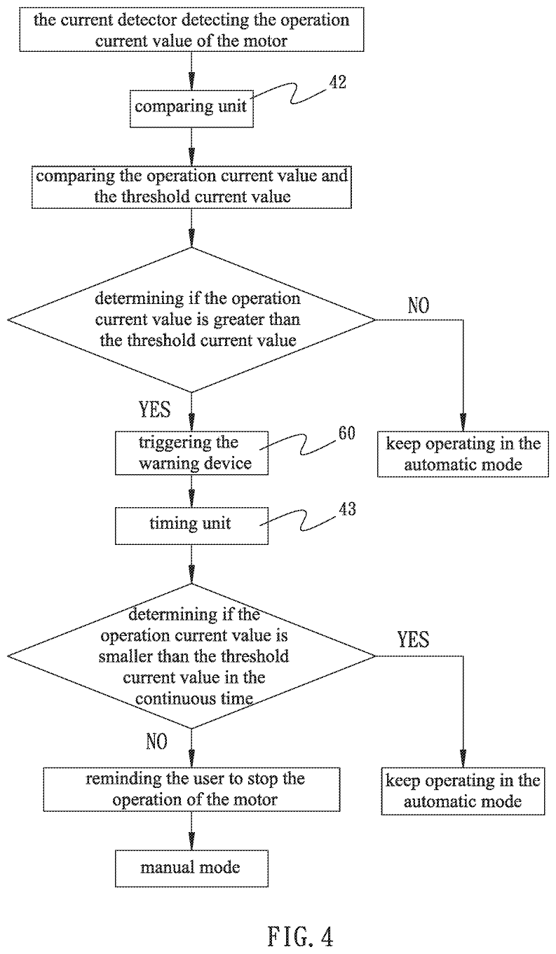

Also, as shown by FIG. 2 and FIG. 4, when the warning device 60 is triggered, the timing unit 43 is simultaneously triggered. If the damaged or rusted portion on the screw member is relatively narrow, or the fastening member is stuck for a short moment, upon the fastening member leaving the damaged, rusted, or stuck portion on the screw member in the continuous time 413, and upon the comparing unit 42 acquiring that the operation current value 21 is smaller than the threshold current value 411, the warning device 60 will stop being triggered, so that the user will be allowed to continue electrically driving the fastening member to rotate on the screw member with the first torque. Thus, the convenience of usage is achieved.

In addition, as shown by FIG. 1, FIG. 2, and FIG. 5, for preventing the rotation direction of the motor 20 being different from the rotation direction of the ratchet device 13, when the rotation direction of the motor 20 defined by the switch 80 and the rotation direction of the ratchet device 13 defined by the direction changing member 131 are different, the motor 20 is in a no-load status, and while the comparing unit 42 determines that the operation current value 21 is smaller than or equal to the low-load current value 412, the controller 40 triggers the warning device 60, so as to notify the user of that the rotation directions of the motor 20 and the ratchet device 13 are inconsistent, thus reminding the user to switch the rotation direction or stop the operation. Thus, a double-protection and a fool-proofing functions are achieved.

The particular embodiments of the invention above have been described for purposes of illustration, instead of limiting the scope of the invention. Various modifications and enhancements may be made without departing the scope covered by the invention.

What is claimed is:

1. An electric wrench which is operated in an electric mode and a manual mode; in the electric mode, a first torque is applied for driving a fastening member to rotate on a screw member; in the manual mode, a second torque is applied for loosening or releasing the fastening member with respect to the screw member; the first torque is smaller than the second torque; the electric wrench comprises:
a wrench body with one end having a head portion and an opposite end having a handle portion, a ratchet device rotatable disposed on the head portion for driving the fastening member, a transmission shaft disposed in the handle portion, the transmission shaft having one end connected with the ratchet device;
a motor disposed in the handle portion and connected with another end of the transmission shaft;
a current sensor electrically connected with the motor for detecting an operation current value of the motor;
a controller electrically connected with the motor and the current sensor, the controller having a setting unit and a comparing unit, the setting unit applied for setting a threshold current value, the comparing unit applied for comparing the operation current value and the threshold current value;
a switch disposed on the handle portion and electrically connected with the controller for activating and deactivating an operation of the motor; and
a warning device electrically connected with the controller,
wherein, in the electric mode, when the operation current value is greater than the threshold current value, the warning device is triggered for reminding a user to stop the operation of the motor and switch the wrench to the manual mode.

2. The electric wrench of claim 1, further comprising a power device electrically connected with the controller and the motor, the powering device having a positive voltage and a negative voltage for providing a positive voltage and a negative voltage needed by the controller and the motor, respectively, and the warning device being a buzzer.

3. The electric wrench of claim 2, wherein a current value output by the powering device is equal to the operation current value, and the threshold current value is equal to 70% to 80% of the operation current value.

4. The electric wrench of claim 1, wherein the operation current value is from 1.5 amperes to 6.5 amperes.

5. The electric wrench of claim 2, wherein the warning device has a first connection pin and a second connection pin, the first connection pin electrically connected with the controller, the second connection pin connected with the positive voltage; when the controller provides a low level signal to the warning device, the warning device is triggered; when the controller provides a high level signal to the warning device, the warning device is not triggered.

6. The electric wrench of claim 5, wherein a transistor is electrically connected between the first connection pin and the controller; a first resistor is electrically connected between the second connection pin and the positive voltage; a base of the transistor is electrically connected with an end of a second resistor; another end of the second resistor is electrically connected with the controller; and a collector of the transistor is electrically connected with the first connection pin.

7. The electric wrench of claim 2, wherein a power amount provided by the powering device is between 3 coulombs to 4 coulombs, the positive voltage is between 3 volts to 12 volts, and the negative voltage is 0 volts.

8. The electric wrench of claim 1, wherein the switch is applied for controlling the motor to drive the transmission shaft to rotate in a clockwise or counterclockwise direction; the ratchet device further comprises a direction changing member for controlling the ratchet device to rotate in two opposite directions; when the rotation direction of the motor defined by the switch is different from the rotation direction of the ratchet device defined by the direction changing member, the warning device is triggered.

9. The electric wrench of claim 8, wherein the setting unit is applied for setting a low-load current value, and the comparing unit is applied for comparing the low-load current value and the operation current value, such that when the operation current value is smaller than or equal to the low-load current value, the controller triggers the warning device.

10. The electric wrench of claim 9, wherein the threshold current value is greater than the low-load current value.

11. The electric wrench of claim 10, wherein the threshold current value is greater than 2 to 3 times the low-load current value.

12. The electric wrench of claim 1, wherein the controller has a timing unit; the setting unit is applied for setting a continuous time, and the timing unit is applied for calculating the continuous time; when the warning device 60 is triggered, the timing unit is simultaneously triggered; during the continuous time, when the operation current value is smaller than the threshold current value, the warning device is stopped being triggered; the continuous time is between 2 seconds to 6 seconds.

13. A protection method for an electric wrench motor, the electric wrench which being operated in an electric mode and a manual mode; in the electric mode, a motor applies a first torque for driving a fastening member to rotate on a screw member; in the manual mode, the motor applies a second torque for loosening or releasing the fastening member with respect to the screw member; the first torque is smaller than the second torque; the method comprises following steps:
the motor being electrically connected with a current sensor, a controller, and a warning device; the current sensor being applied for detecting an operation current value of the motor, the controller being applied for setting a threshold current value;
during an operation in the electric mode, the current sensor detecting the operation current value of the motor; and
when the operation current value is greater than the threshold current value, the controller triggers the warning device for reminding a user to stop an operation of the motor and switch the wrench to the manual mode.

14. The method of claim 13, wherein when the warning device is triggered, and when operation current value is smaller than the threshold current value in a continuous time, the warning device is stopped being triggered.

15. The method of claim 13, wherein the controller is applied for setting a low-load current value, such that when the operation current value is smaller than or equal to the low-load current value, the warning device is triggered for reminding the user to stop the operation of the motor and switch the wrench to the manual mode.
